(19) United States
(12) Patent Application Publication
(10) Pub. No.: US 2013/0273367 A1
(43) Pub. Date: Oct. 17, 2013

(54) COMPOSITION FOR WIRE COATING MATERIAL, INSULATED WIRE, AND WIRING HARNESS

(71) Applicants: Tatsuya Shimada, Yokkaichi-shi (JP); Masashi Kimura, Yokkaichi-shi (JP); Kousuke Shiraki, Yokkaichi-shi (JP); Masashi Sato, Yokkaichi-shi (JP)

(72) Inventors: Tatsuya Shimada, Yokkaichi-shi (JP); Masashi Kimura, Yokkaichi-shi (JP); Kousuke Shiraki, Yokkaichi-shi (JP); Masashi Sato, Yokkaichi-shi (JP)

(73) Assignees: AUTONETWORKS TECHNOLOGIES, LTD., Yokkaichi-shi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP)

(21) Appl. No.: 13/993,562

(22) PCT Filed: Jan. 19, 2012
(86) PCT No.: PCT/JP2012/051099

§ 371 Date: Jun. 12, 2013

(30) Foreign Application Priority Data
Jan. 31, 2011 (JP) 2011-017369

(51) Int. Cl. H01B 3/30

(52) U.S. Cl. CPC H01B 3/307; H01B 3/308
USPC 428/389; 524/94

(57) ABSTRACT

To provide a composition for a wire coating material, requiring no electron irradiation crosslinking and a less filler, that can produce a crosslinked coat having a high heat resistance, gel fraction and peel property at high temperature, and provide an insulated wire, and a wiring harness. A wire coating material composition contains (A) silane-grafted polyolefin, (B) undenatured polyolefin, (C) functional-group modified polyolefin modified by functional groups of a carboxylic acid group, an acid anhydride group, an amino group and an epoxy group, (D) a bromine flame retardant having a phthalimide structure or the flame retardant and an antimony trioxide, (E) a crosslinking catalyst batch containing a resin containing a crosslinking catalyst, and (F) a zinc oxide and an imidazole compound or a zinc sulfide, (G) a triazine hindered phenolic antioxidant having a melting point of 150 degrees C. or more, and (H) a triazole derivative or a hydrazide metal deactivator.

### TECHNICAL FIELD

The present invention relates to a composition for a wire coating material, an insulated wire, and a wiring harness, and more specifically relates to a composition for a wire coating material favorably used for a wire coating material of an insulated wire that is used in a location of which high heat resistance is required such as a wiring harnesses for automobile, and relates to an insulated wire containing the composition, and a wiring harness containing the composition.

### BACKGROUND ART

In recent years, hybrid cars become widespread, so that high voltage resistance and high heat resistance are required of wires and connectors for automobile. Conventionally, crosslinked polyvinyl chloride wires or crosslinked polyolefin wires are used as insulated wires used at sites where high heat is generated such as wiring harnesses for automobiles. These insulated wires are crosslinked mainly in methods for cross-linking the insulated wires by electron irradiation.

However, there arises a problem in that the cost for facilities rises because an expensive device for electron irradiation crosslinking is required, which leads to increases in the cost of product. Thus, a silane-crosslinkable polyolefin composition, which can be crosslinked with low-cost facilities, has been receiving attention (see PTL 1 to PTL 3).

### RELATED ART DOCUMENTS

### Patent Documents

PTL 1: Japanese Unexamined Patent Application Publication No. 2000-212291

PTL 2: Japanese Unexamined Patent Application Publication No. 2000-294039

PTL 3: Japanese Unexamined Patent Application Publication No. 2006-131720

### SUMMARY OF INVENTION

### Problems to be Solved by the Invention

However, because a filler that defines a flame retardant agent needs to be added to the silane-crosslinkable polyolefin composition in order to satisfy flame retardancy that is a main essential property required of a wire for automobile, there arises a problem in that a mechanical property of the wire for automobile is deteriorated when an inorganic flame retardant agent typified by metal hydroxide is added as the filler because a great amount of the inorganic flame retardant agent needs to be added. In addition, there arises a problem in that a gel fraction that defines an indicator of crosslinking degree tends to decrease when a halogenous organic flame retardant agent having a high flame-retardant effect is used.

In addition, when a silane-crosslinkable material which is referred to also as a water-crosslinkable material, is used, crosslinking is promoted by moisture in the air during a heat molding process, so that there arises a problem in that an unintended substance is generated. In order to solve this problem, it is necessary to minimize the number of times of the heating process as much as possible. Thus, it is general to prepare a masterbatch that contains the flame retardant agent and a non-silane resin, and then mix the masterbatch and silane-crosslinkable polyolefin. However, because the non-silane resin defines a non-crosslinkable resin, containing the non-silane resin reduces the crosslinking degree of the crosslinked resin. When the crosslinked resin has a reduced cross-linking degree, there arises a problem in that the crosslinked resin is easily melted at high temperature, so that electric wires containing the silane-crosslinkable material adhere to each other.

The present invention is made in view of the problems described above, and an object of the present invention is to provide a composition for a wire coating material that requires no electron irradiation crosslinking, and requires a filler that defines a flame retardant agent as less as possible, and from which a crosslinked coat that has a high heat resistance and a high gel fraction, and has a high peel property even when exposed to high temperature can be produced, and to provide an insulated wire containing the composition, and a wiring harness containing the composition.

### Means of Solving the Problems

To achieve the objects and in accordance with the purpose of the present invention, a composition for a wire coating material according to the present invention contains

(A) silane-grafted polyolefin that is polyolefin to which a silane coupling agent is grafted,

(B) undenatured polyolefin,

(C) functional-group modified polyolefin that is modified by a one or a plurality of functional groups selected from the group consisting of a carboxylic acid group, an acid anhydride group, an amino group, and an epoxy group,

(D) either one of a bromine flame retardant having a phthalimide structure, and a bromine flame retardant having a phthalimide structure and an antimony trioxide,

(E) a crosslinking catalyst batch that contains a resin containing a crosslinking catalyst that is dispersed in the resin,

(F) either one of a zinc oxide and an imidazole compound, and a zinc sulfide,

(G) a hindered phenolic antioxidant of triazine series having a melting point equal to or higher than 150 degrees C., and

(H) either one of a triazole derivative, and a hydrazide metal deactivator.

In another aspect of the present invention, an insulated wire according to the present invention includes a wire coating material that contains the composition for the wire coating material described above that is water-crosslinked.

Yet, in another aspect of the present invention, a wiring harness according to the present invention includes the insulated wire described above.

### EFFECTS OF THE INVENTION

Containing the (A) to (H) components described above, the composition for the wire coating material according to the present invention, the insulated wire according to the present invention, and the wiring harness according to the present invention are excellent in flame retardancy, and heat resistance. The wire coating material according to the present invention, the insulated wire according to the present invention, and the wiring harness according to the present invention require no electron irradiation crosslinking, and require a filler that defines a flame retardant agent as less as possible, and a crosslinked coat made from the composition has a high heat resistance and a high gel fraction, and has a high peel property even when exposed to high temperature.

### EMBODIMENTS FOR CARRYING OUT THE INVENTION

Hereinafter, a detailed description of a composition for a wire coating material according to preferred embodiments of the present invention will now be provided. Examples of polyolefins used in (A) silane-grafted polyolefin, (B) undenatured polyolefin, and (C) functional-group modified polyolefin that are contained in the composition for the wire coating material according to the present invention include the following olefinic resins.

Examples of the olefinic resin include polyolefin such as polyethylene and polypropylene, a homopolymer of the other olefins, an ethylene copolymer such as an ethylene-alpha-olefin copolymer, an ethylene-vinyl acetate copolymer, an ethylene-acrylic ester copolymer and an ethylene-methacrylic ester copolymer, and a propylene copolymer such as a propylene-alpha-olefin copolymer, a propylene-vinyl acetate copolymer, a propylene-acrylic ester copolymer and a propylene-methacrylic ester copolymer. The olefinic resins may be used singly or in combination. Among the olefinic resins described above, the polyethylene, the polypropylene, the ethylene-vinyl acetate copolymer, the ethylene-acrylic ester copolymer and the ethylene-methacrylic ester copolymer are preferably used.

Examples of the polyethylene include high density Polyethylene (HDPE), middle density polyethylene (MDPE), low density polyethylene (LDPE), linear low density polyethylene (LLDPE) and very low density polyethylene (VLDPE), and metallocene very low density polyethylene. The polyethylenes may be used singly or in combination. Among the polyethylenes described above, the low density polyethylene typified by the metallocene very low density polyethylene is preferably used. Using the low density polyethylene improves the flexibility and extrudability of a wire, which can leads to better productivity.

Examples of the olefinic resin may include an olefin-based elastomer such as an ethylene elastomer (PE elastomer) and a propylene elastomer (PP elastomer). The olefinic resins may be used singly or in combination.

(A) The silane-grafted polyolefin is polyolefin to which a silane coupling agent is graft polymerized. It is preferable to use a one or a plurality of resins that are selected from the group consisting of the VLDPE, LLDPE and LDPE for the polyolefin from the viewpoint of extrudability and productivity of a wire in coating the wire with the composition, and flexibility of the wire.

Examples of a silane coupling agent used in (A) the silane-graftedpolyolefin include vinylalkoxysilane such as vinyltrimethoxysilane, vinyltriethoxysilane and vinyltributoxysilane, normal hexyl trimethoxysilane, vinylacetoxysilane, gamma-methacryloxypropyltrimethoxysilane, and gamma-methacryloxypropylmethyldimethoxysilane. Among the silane coupling agents described above, a single kind of silane coupling agent may be used alone, or two or more kinds of silane coupling agents may be used in combination.

The content of the silane coupling agent in (A) the silane-grafted polyolefin is preferably in the range of 0.5 to 5 parts by mass, and more preferably in the range of 3 to 5 parts by mass with respect to 100 parts by mass of the polyolefin onto which the silane coupling agent is to be grafted. If the content is less than 0.5 parts by mass, the graft amount of the silane coupling agent is too small, which makes it difficult for the composition to obtain a sufficient crosslinking degree during a silane crosslinking process. On the other hand, if the content is more than 5 parts by mass, a crosslinking reaction proceeds excessively to generate a gel-like material during a kneading process. In such a case, asperities are liable to appear on a product surface, which decreases mass productivity of the product. In addition, melt viscosity of the composition becomes too high and an excessive load is applied on an extruder, which results in decreased workability.

A graft amount of the silane coupling agent (a mass ratio of the grafted silane coupling agent to the polyolefin before silane grafting is performed) is preferably 15% by mass or less, more preferably 10% by mass or less, and yet more preferably 5% by mass or less from the viewpoint of preventing an unintended substance from being generated due to excessive crosslinking during a wire coating process. On the other hand, the graft amount is preferably 0.1% by mass or more, more preferably 1% by mass or more, and yet more preferably 2.5% by mass or more from the viewpoint of increasing the crosslinking degree (gel fraction) of a wire coat.

In general, the silane coupling agent is grafted onto the polyolefin generally in a manner such that a free-radical generating agent is added to the polyolefin and the silane coupling agent and all the components are mixed with the use of a twin-screw extruder. It is also preferable that the silane coupling agent should be grafted onto the polyolefin in a method such that the silane coupling agent is added when grafting the silane coupling agent onto the polyolefin. The silane-grafted polyolefin prepared by grafting the silane coupling agent onto the polyolefin is kept as a silane-grafted polyolefin batch while separated from a crosslinking catalyst batch and a flame retardant batch until the composition is kneaded.

Examples of the free-radical generating agent described above include an organic peroxide such as dicumyl peroxide (DCP), benzoyl peroxide, dichlorobenzoyl peroxide, di-tert-butyl peroxide, butyl peracetate, tert-butyl perbenzoate, and 2,5-dimethyl-2,5-di(tert-butyl peroxy)hexane. Among the free-radical generating agents described above, the dicumyl peroxide (DCP) is preferably used. For example, when the dicumyl peroxide (DCP) is used as the free-radical generating agent, it is preferable that the silane-grafted polyolefin batch should be adjusted to be 200 degrees C. or higher in order to graft polymerize the silane coupling agent onto the polyolefin.

The content of the free-radical generating agent is preferably in the range of 0.025 to 0.1 parts by mass with respect to 100 parts by mass of the polyolefin to be silane-modified. If the content is less than 0.025 parts by mass, a grafting reaction of the silane coupling agent does not proceed sufficiently, which makes it difficult for the composition to obtain a desired gel fraction. On the other hand, if the content is more than 0.1 parts by mass, the ratio of breaking the molecules of the polyolefin rises, so that unintentional crosslinking of the peroxide is liable to proceed. In such a case, a crosslinking reaction of the polyolefin proceeds excessively, and asperities are liable to appear on a product surface when the silane-grafted polyolefin batch is mixed with the flame retardant agent and the crosslinking catalyst batch. To be specific, when the wire coating material is formed, asperities are liable to appear on a surface of the wire coating material, and the wire is liable to have decreased workability and marred surface appearance.

(B) The unmodified polyolefin defines polyolefin that is not modified by a silane coupling agent or a functional group. It is preferable to use a one or a plurality of polyolefins that are selected from the group consisting of the VLDPE, LLDPE and LDPE, for the unmodified polyolefin from the viewpoint of providing the wire with flexibility, and allowing a filler that defines a flame retardant agent to be dispersed well. In addition, it is preferable to add a small amount of polypropylene for hardness adjustment in order to adjust the flexibility of the wire.

As the polyolefin that is used in (C) the functional-group modified polyolefin, it is preferable to use polyolefin that belongs to a same group as the polyolefin that is used as (B) the unmodified polyolefin described above from the viewpoint of compatibility. In addition, polyethylene such as the VLDPE and LDPE is preferably used as the polyolefin used in (C) the functional-group modified polyolefin from the viewpoint of providing the wire with flexibility, and allowing a filler that defines a flame retardant agent to be dispersed well.

As a functional group that is used in (C) the functional-group modified polyolefin, a one or a plurality of functional groups selected from the group consisting of a carboxylic acid group, an acid anhydride group, an amino group, and an epoxy group are used. Among the functional groups described above, the maleic acid group, the epoxy group and the amino group are preferably used because these functional groups can improve an adhesion property to fillers such as a bromine flame retardant, an antimony trioxide and a zinc oxide to prevent the strength of the resin from decreasing. The modification ratio by the functional group is preferably in the range of 0.05 to 10 parts by mass with respect to 100 parts by mass of the polyolefin. If the modification ratio of the functional group is more than 10 parts by mass, a property of stripping a coat at the time of processing the ends of the wire could be degraded. On the other hand, if the modification ratio by the functional group is less than 0.05 parts by mass, the effect of modification by the functional group cannot be achieved sufficiently.

The polyolefin is modified by the functional group in a method of graft polymerizing a compound containing the functional group onto the polyolefin, or in a method of copolymerizing a compound containing the functional group and an olefin monomer to obtain an olefin copolymer.

Examples of a compound in which the carboxylic acid group and/or the acid anhydrous group that defines the functional group is introduced include an alpha, beta-unsaturated dicarboxylic acid such as a maleic acid, a fumaric acid, a citraconic acid and an itaconic acid, anhydrides of the acids described above, and an unsaturated monocarboxylic acid such as an acrylic acid, a methacrylic acid, a fran acid, a crotonic acid, a vinylacetic acid and a pentane acid.

Examples of a compound in which the amino group that defines the functional group is introduced include aminoethyl(meth)acrylate, propylaminoethyl(meth)acrylate dimethyl aminoethyl(meth)acrylate, diethyl aminoethyl(meth)acrylate, dibutyl aminoethyl(meth)acrylate, aminopropyl(meth)acrylate, phenylaminoethyl(meth)acrylate, and cyclohexylaminoethyl(meth)acrylate.

Examples of a compound in which the epoxy group that defines the functional group is introduced include glycidyl acrylate, glycidyl methacrylate, an itaconic monoglycidyl ester, a butene tricarboxylic acid monoglycidyl ester, a butene tricarboxylic acid diglycidyl ester, a butene tricarboxylic acid triglycidyl ester, glycidyl esters such as an alpha-chloroacrylic acid, a maleic acid, a crotonic acid and a fumaric acid, glycidyl ethers such as a vinyl glycidyl ether, an allyl glycidyl ether, a glycidyl oxyethyl vinyl ether and a styrene-p-glycidyl ether, and p-glycidyl styrene.

The ratio of the content of (A) the silane-grafted polyolefin is 30 to 90 parts by mass with respect to 100 parts by mass of the total content of the (A), (B) and (C) resin components, and the ratio of the total content of (B) the unmodified polyolefin and (C) the functional-group modified polyolefin is 10 to 70 parts by mass with respect to 100 parts by mass of the total content of the (A), (B) and (C) resin components. The content ratio of (B) the unmodified polyolefin to (C) the functional-group modified polyolefin is preferably in the range of 95:5 to 50:50 from the viewpoint of providing excellent compatibility, and improved productivity, and allowing the flame retardant to be dispersed well.

As (D) a flame retardant that is contained in the composition for the wire coating material according to the present invention, a bromine flame retardant having a phthalimide structure is used singly, or the flame retardant having the phthalimide structure and an antimony trioxide are used in combination. The flame retardant having the phthalimide structure has a low degree of solubility in hot xylene, so that a cured coat that is made from the composition has an improved gel fraction. Examples of the bromine flame retardant having the phthalimide structure include ethylene bis tetrabromophthalimide and ethylene bis tribromophthalimide.

It is preferable to singly use one of the bromine flame retardants having the phthalimide structure described above for the bromine flame retardant. It is also preferable to use the bromine flame retardants having the phthalimide structure described above in combination with the following bromine flame retardants insofar as a gel fraction within a desired range can be obtained. Examples of the bromine flame retardants include ethylenebis (pentabromobenzene) [also known as bis (pentabromophenyl) ethane], tetrabromobisphenol A (TBBA), hexabromocyclododecane (HBCD), TBBA-carbonate oligomer, TBBA-epoxy oligomer, brominated polystyrene, TBBA-bis (dibromopropylether), poly (dibromopropylether), and hexabromobenzene (HBB).

The antimony trioxide is used as a flame-retardant auxiliary agent for the bromine flame retardant. Use of the antimony trioxide together with the bromine flame retardant generates a synergistic effect to improve the flame retardancy of the composition. The content ratio of the bromine flame retardant having the phthalimide structure to the antimony trioxide is preferably in the range of 3:1 to 2:1 at the equivalent ratio. It is preferable to use antimony trioxide having a purity of 99% or more. The antimony trioxide is prepared by pulverizing and microparticulating antimony trioxide that is produced as a mineral. It is preferable that the microparticulated antimony trioxide should have an average particle size equal to or less than 3 μm, and more preferable that the microparticulated antimony trioxide should have an average particle size equal to or less than 1 μm. If the average particle size of the antimony trioxide is larger, the interface strength between the antimony trioxide and the resins could be decreased. In addition, it is preferable that the antimony trioxide should be subjected to a surface treatment in order to control a particle system or improve the interface strength between the antimony trioxide and the resins. Examples of a surface treatment agent to be used include a silane coupling agent, a higher fatty acid and a polyolefin wax.

The content of (D) the bromine flame retardant, or the content of (D) the bromine flame retardant and the antimony trioxide is preferably in the range of 10 to 70 parts by mass, and more preferably in the range of 20 to 60 parts by mass with respect to 100 parts by mass of the total content of the (A), (B) and (C) resin components. If the content of the flame retardant agent component is less than 10 parts by mass, the composition has insufficient flame retardancy. On the other hand, if the content of the flame retardant agent component is more than 70 parts by mass, the flame retardant agent component cannot be mixed well to cause coagulation of the flame retardant agent, so that the interface strength between the flame retardant agent and the resins is decreased to deteriorate a mechanical property of the wire. It is to be noted that when the bromine flame retardant and the antimony trioxide are used in combination, the content of (D) the flame retardant agent component defines the total content of the bromine flame retardant and the antimony trioxide.

(E) A crosslinking catalyst batch that is contained in the composition for the wire coating material according to the present invention defines a batch prepared by dispersing a crosslinking catalyst into a resin that defines a binder. Using the crosslinking catalyst batch can prevent occurrence of an excess reaction of the composition that could occur by being mixed with the flame retardant agent, and can easily adjust the additive amount of the crosslinking catalyst. The crosslinking catalyst is usually added to the resin components during a wire coating process because a crosslinking reaction proceeds if the crosslinking catalyst is mixed with the silane-grafted polyolefin batch containing the silane-graftedpolyolefin (the batch is referred to also as an a component).

The crosslinking catalyst defines a silanol condensation catalyst for silane crosslinking the silane-grafted polyolefin. Examples of the crosslinking catalyst include a metal carboxylate containing a metal such as tin, zinc, iron, lead and cobalt, a titanate ester, an organic base, an inorganic acid, and an organic acid. Specific examples of the crosslinking catalyst include dibutyltin dilaurate, dibutyltin dimalate, dibutyltin mercaptide (e.g., a dibutyltin bis-octylthioglycol ester, and a dibutyltin beta-mercaptopropionate polymer), dibutyltin diacetate, dioctyltin dilaurate, stannous acetate, stannous caprylate, lead naphthenate, cobalt naphthenate, barium stearate, calcium stearate, titanic acid tetrabutyl ester, titanic acid tetranonyl ester, dibutylamine, hexylamine, pyridine, a sulfuric acid, a hydrochloric acid, a toluenesulfonic acid, an acetate, a stearic acid, and a maleic acid.

Among the crosslinking catalysts described above, the dibutyltin compounds such as the dibutyltin dilaurate, the dibutyltin dimalate, and the dibutyltin mercaptide are preferably used because a silane crosslinking reaction easily proceeds.

It is preferable to use polyolefin as the resin used in the crosslinking catalyst batch, and more preferable to use LDPE, LLDPE or VLDPE. These resins are preferably used for the same reasons as the silane-grafted polyolefin, the undenatured polyolefin and the functional-group modified polyolefin are used. It is advantageous to select resins of the same group from the viewpoint of compatibility. Specific examples of the resin that can be used in the crosslinking catalyst batch include the polyolefins described above.

The content of the crosslinking catalyst in the crosslinking catalyst batch is preferably in the range of 0.5 to 5 parts by mass, and more preferably in the range of 1 to 5 parts by mass with respect to 100 parts by mass of the resin. component in the crosslinking catalyst batch. If the content of the crosslinking catalyst is less than 0.5 parts by mass, a crosslinking reaction does not proceed well. If the content is more than 5 parts by mass, the catalyst is not dispersed well. If the content is less than 1 part by mass, the catalyst has low reactivity.

The content of the crosslinking catalyst batch is preferably in the range of 2 to 20 parts by mass, and more preferably in the range of 5 to 15 parts by mass with respect to 100 parts by mass of the total content of the (A), (B) and (C) polyolefins. If the content is less than 2 parts by mass, a crosslinking reaction does not proceed well, which could result in partial crosslinking. On the other hand, if the content is more than 20 parts by mass, the non-crosslinkable non-flame-retardant resin increases to exert a harmful influence on the flame retardancy and weatherability of the composition.

(F) A zinc oxide and an imidazole compound, or a zinc sulfide that is contained in the composition for the wire coating material according to the present invention is used as an additive to improve heat resistance of the composition. Even when the zinc oxide and the imidazole compound are contained in combination, or the zinc sulfide is contained alone, a same effect of heat resistance can be produced.

The zinc oxide is produced in a method of air oxidizing zinc vapors that exude from a zinc mineral by adding a reducing agent such as coke to the zinc mineral and firing the zinc mineral, or in a method of producing from a zinc sulfide or a zinc chloride. The production method of the zinc oxide is not limited specifically, and the zinc oxide maybe produced in either method. The zinc sulfide may be produced in a known production method. It is preferable that the zinc oxide or the zinc sulfide should have an average particle size equal to or less than 3 μm, and more preferable that the zinc oxide or the zinc sulfide should have an average particle size equal to or less than 1 μm. If the average particle size of the zinc oxide or the zinc sulfide is smaller, the interface strength between the zinc oxide or the zinc sulfide and the resins is improved, and improved dispersibility of the zinc oxide or the zinc sulfide can be expected.

Mercaptobenzimidazole is preferably used as the imidazole compound described above. Examples of the mercaptobenzimidazole include 2 -mercaptobenzimidazole, 2-mercaptomethylbenzimidazole, 4-mercaptomethylbenzimidazole, and 5-mercaptomethylbenzimidazole, and zinc salts of the mercaptobenzimidazoles described above. Among the mercaptobenzimidazoles described above, the 2-mercaptobenzimidazole and the zinc salt of the 2-mercaptobenzimidazole are preferably used because the 2-mercaptobenzimidazole and the zinc salt of the 2-mercaptobenzimidazole are stable at high temperatures because the 2-mercaptobenzimidazole and the zinc salt of the 2-mercaptobenzimidazole have high melting points, and only a small amount of the 2-mercaptobenzimidazole or the zinc salt of the 2-mercaptobenzimidazole sublimes during the mixing.

If the content of the zinc oxide and the imidazole compound, or the content of the zinc sulfide is small, an effect of improving heat resistance cannot be obtained sufficiently. On the other hand, if the content is too large, the particles are liable to coagulate, and the wire is liable to have marred surface appearance, and mechanical properties such as wear resistance of the wire could be deteriorated. Thus, the content of the zinc oxide and the imidazole compound, and the content of the zinc sulfide are preferably in the ranges described below. When the zinc oxide and the imidazole compound are selected to use, the content of each of the zinc oxide and the imidazole compound is preferably 1 to 15 parts by mass with respect to 100 parts by mass of the total content of the (A), (B) and (C) resin components. When the zinc sulfide is selected to use, the content of the zinc sulfide is 1 to 15 parts by mass with respect to 100 parts by mass of the total content of the (A), (B) and (C) resin components.

For (G) a hindered phenolic antioxidant of triazine series having a melting point equal to or higher than 150 degrees C. that is contained in the composition for the wire coating material according to the present invention, the following compounds are used.
N,N′-hexane-1,6,diylbis[3-(3,5-di-tert-butyl-4hydr oxyphenyl)propion amide]
3,3′,3″,5,5′,5″-hexa-tert-butyl-a-a′-a″(mesitylene -2,4,6,-triyl)tri-p-cresol
1,3,5-tris[(4-tert-butyl-3-hydroxy-2,6-xylyl)methy l]-1,3,5-triazine-2,4,6(1H,3H,5H)-trione
1,3,5-tris (3,5-di-tert-butyl-4-hydroxybenzyl)-1,3, 5-triazine-2,4,6(1H, 3H, 5H)-trione

Among the hindered phenolic antioxidants of triazine series described above, 1,3,5-tris[(4-tert-butyl-3-hydroxy-2, 6-xylyl)methyl]-1,3,5-triazine-2,4,6(1H, 3H, 5H)-trione, and 1,3,5-tris (3,5-di-tert-butyl-4-hydroxybenzyl)-1,3,5-triazine-2,4,6(1H,3H,5H)-trione are preferably used.

In the present invention, because the hindered phenolic antioxidant of triazine series having a melting point equal to or higher than 150 degrees C. is contained in the composition, when an insulated wire including a wire coating material made from the composition is exposed to high temperature, occurrence of a bloom that defines a white precipitation of hindered phenol can be prevented. In addition, even when the insulated wires are exposed to high temperature while being in contact with each other, the insulated wires are free from a problem of adhering to each other.

It is preferable that the hindered phenolic antioxidant of triazine series should have a melting point equal to or higher than 200 degrees C. It is preferable to use 1,3,5-tris(3,5-di-tert-butyl-4-hydroxybenzyl)-1,3,5-triazine-2,4,6(1H,3H,5H)-trione as the hindered phenolic antioxidant of triazine series because 1,3,5-tris(3,5-di-tert-butyl-4-hydroxybenzyl)-1,3,5-triazine-2,4,6(1H,3H,5H)-trione has a melting point of 225 degrees C., has an excellent peel property, which can improve the slipping property of the wire surface, and has the high effect of an antioxidant, which can increase the life-span of the wire.

The content of the hindered phenolic antioxidant of triazine series is preferably in the range of 0.5 to 5 parts by mass, and more preferably in the range of 0.5 to 3 parts by mass with respect to 100 parts by mass of the total content of the (A), (B) and (C) polyolefins. If the content of the hindered phenolic antioxidant of triazine series is less than 0.5 parts by mass, the composition has lowered resistance to aging, which could result in a collapse of the wire coat when the wire coat is exposed to heat for a long time. On the other hand, if the content is more than 5 parts by mass, the hindered phenolic antioxidant of triazine series has lowered compatibility with the resins, and the wire is liable to have marred surface appearance.

At least one of (H) a triazole derivative and a hydrazide metal deactivator is contained in the composition for the wire coating material according to the present invention. Examples of the triazole derivative include 3-(N-salicyloyl)amino-1,2,4-triazole, and 3-(N-salicyloyl)amino-1,2,3-triazole. Examples of the hydrazide compound include N′ethyl-2-fluoro-N-methyl acetohydrazide, 2′,ethyl-2-fluoro-1′-methyl acetohydrazide, and 2,3-bis[3-(3,5-di-tert-butyl-4-hydroxyphenyl) propionyl]propiono hydrazide.

The content of the triazole derivative or the hydrazide metal deactivator is preferably in the range of 0.3 to 3 parts by mass, and more preferably in the range of 0.3 to 1.5 parts by mass with respect to 100 parts by mass of the total content of the (A), (B) and (C) polyolefins. If the content of the triazole derivative or the hydrazide metal deactivator is less than 0.3 parts by mass, a metal used in a conductor could be transferred to the wire coat, which could result in a collapse of the wire coat. On the other hand, if the content is more than 3 parts by mass, the triazole derivative or the hydrazide metal deactivator has lowered compatibility with the resins, and could have its color changed by reacting with a metal such as iron and nickel that is often contained as impurities.

It is preferable that the composition for the wire coating material according to the present invention should further contain a general additive in addition to the components described above. Examples of the additive favorably used include hindered phenolic antioxidants other than the hindered phenolic antioxidant described above, and an amine copper inhibitor. In addition, an additive that is generally used for a wire coating material can be used.

If a small amount of filler such as magnesium hydroxide, magnesium oxide and calcium carbonate is added as the additive, the hardness of the resins can be adjusted, whereby workability and high heat deformation resistance can be improved. However, if a great amount of the filler is added, the resins are liable to decrease in strengths, so that the content of the filler is preferably about 30 parts by mass with respect to 100 parts by mass of the (A), (B) and (C) polyolefins.

Next, a description of an insulated wire according to the present invention will be provided. The insulated wire according to the present invention includes a conductor and an insulation layer coated on the conductor, the insulation layer being made from a wire coating material that is prepared by water-crosslinking the composition for the wire coating material described above. The diameter, the material and other properties of the conductor are not specifically limited, and may be determined appropriately depending on intended use of the insulated wire. The conductor is made from copper, a copper alloy, aluminum or an aluminum copper alloy. The insulation layer made from the wire coating material may have a single-layered configuration, or may have a multi-layered configuration. A wiring harness according to the present invention includes the insulated wire described above.

The ISO 6722 is an international standard used for a wire for automobile. Insulated wires are classified under A to E classes in accordance with the ISO 6722 depending on its allowable temperature limit. Being made from the composition for the wire coating material described above, the insulated wire according to the present invention is excellent in heat resistance, and can be favorably used for a cable for battery where a high voltage is placed. Thus, the insulated wire according to the present invention can have the properties of C class where the required allowable temperature limit is 125 degrees C., or the properties of D class where the required allowable temperature limit is 150 degrees C.

In the insulated wire according to the present invention, it is preferable that the wire coating material should have a crosslinking degree equal to or more than 50%, and more preferable that the wire coating material should have a crosslinking degree equal to or more than 60% from the viewpoint of heat resistance. The crosslinking degree is determined by a gel fraction that is generally used as an indicator that indicates a crosslinking state of a crosslinked wire. For example, the gel fraction of a crosslinked wire for automobile can be measured in accordance with the JASO-D608-92.

The crosslinking degree of the wire coating material can be adjusted by the graft amount of the silane coupling agent grafted on the polyolefin, the kind and amount of the crosslinking catalyst, or the conditions for water-crosslinking (temperature and duration).

Next, a description of a method for producing the insulated wire described above will be provided. The insulated wire is produced by subjecting a b component (a flame retardant batch) that contains (B) the undenatured polyolefin, (C) the functional-group modified polyolefin, (D) the either one of the bromine flame retardant having the phthalimide structure, and the bromine flame retardant having the phthalimide structure and the antimony trioxide, (F) the either one of the zinc oxide and the imidazole compound, and the zinc sulfide, (G) the hindered phenolic antioxidant having the melting point equal to or higher than 150 degrees C., and (H) the either one of the triazole derivative and the hydrazide metal deactivator, the a component that contains (A) the silane-grafted polyolefin (the silane-grafted polyolefin batch), and a c component that contains the polyolefin and (E) the crosslinking catalyst dispersed in the polyolefin (the crosslinking catalyst batch) to a kneading process where the components are heat-kneaded. Then, a conductor is extrusion-coated with the wire coating material, and the wire coating material is water-crosslinked. Thus, the insulated wire is produced.

The b component and the c component are kneaded in advance to be pelletized. The silane-grafted polyolefin in the a component is also pelletized.

The pelletized batches (the a component to the c component) are blended with the use of a mixer or an extruder in the kneading process. It is preferable that the extrusion-coating should be performed with the use of a general extrusion molding machine in the coating process. After the coating process, the resin that coats the conductor of the wire is water-crosslinked by being exposed to vapor or water, and thus is silane-crosslinked. It is preferable that the water-crosslinking should be performed at temperatures between room temperature to 90 degrees C. within 48 hours, and more preferable that the water-crosslinking should be performed at temperatures between 60 to 80 degrees C. for 12 to 24 hours.

### EXAMPLE

Hereinafter, Examples of the present invention, and Comparative Examples are presented. However, the present invention is not limited to the Examples.

[Materials Used, Manufacturers, and Other Information]

Materials used in the Examples and Comparative Examples are provided below along with their manufacturers and trade names.

(1) Silane-grafted PP [manuf.: MITSUBISHI CHEMICAL CORPORATION, trade name: LINKLON XPM800HM]

(2) Silane-grafted PE1 [manuf.: MITSUBISHI CHEMICAL CORPORATION, trade name: LINKLON XLE815N (LLDPE)]

(3) Silane-grafted PE2 [manuf.: MITSUBISHI CHEMICAL CORPORATION, trade name: “LINKLON XCF710N” (LDPE)]

(4) Silane-grafted PE3 [manuf.: MITSUBISHI CHEMICAL CORPORATION, trade name: “LINKLON QS241HZ” (HDPE)]

(5) Silane-grafted PE4 [manuf.: MITSUBISHI CHEMICAL CORPORATION, trade name: “LINKLON SH700N” (VLDPE)]

(6) Silane-grafted EVA [manuf.: MITSUBISHI CHEMICAL CORPORATION, trade name: “LINKLON XVF600N”]

(7) PP elastomer [manuf.: JAPAN POLYPROPYLENE CORPORATION, trade name: “NEWCON NAR6”]

(8) PE 1 [manuf.: DUPONT DOW ELASTOMERS JAPAN KK, trade name: “ENGAGE 8450” (VLDPE)]

(9) PE 2 [manuf.: NIPPON UNICAR COMPANY LIMITED, trade name: “NUC8122” (LDPE)]

(10) PE 3 [manuf.: PRIME POLYMER CO., LTD, trade name: “ULTZEX10100W” (LLDPE)]

(11) Maleic acid denatured PE [manuf.: NOF CORPORATION, trade name: “MODIC AP512P”]

(12) Epoxy denatured PE [manuf.: SUMITOMO CHEMICAL CO., LTD., trade name: “BONDFAST E” (E-GMA)]

(13) Maleic acid denatured PP [manuf. : MITSUBISHI CHEMICAL CORPORATION, trade name: “ADMER QB550”]

(14) Bromine flame retardant 1[manuf.: ALBEMARLE JAPAN CORPORATION, tradename: “SAYTEX8010” (ethylenebis (pentabromobenzene))]

(15) Bromine flame retardant 2 [manuf.: SUZUHIRO CHEMICAL CO., LTD., trade name: “FCP-680” (TBBA-bis(dibromopropylether))]

(16) Bromine flame retardant 3 [manuf.: ALBEMARLE JAPAN CORPORATION, trade name: “SAYTEXBT-93” (ethylene bis tetrabromophthalimide)]

(17) Antimony trioxide: [manuf.: YAMANAKA & CO., LTD., trade name: “ANTIMONY TRIOXIDE MSW GRADE”]

(18) Magnesium hydroxide [manuf.: KYOWA CHEMICAL INDUSTRY CO., LTD., trade name: “KISUMA 5”]

(19) Calcium carbonate [manuf.: SHIRAISHI CALCIUM KAISHA, LTD., trade name: “VIGOT15”]

(20) Antioxidant 1 [Manuf.: BASF JAPAN LTD., trade name: “IRGANOX 1010”] (a hindered phenolic antioxidant)
pentaerythritol
   tetrakis[3-(3,5-di-tert-butyl-4-hydroxyphenyl)propio nate]

Melting point: 125 degrees C.

(21) Antioxidant 2 [Manuf.: BASF JAPAN LTD., trade name: “IRGANOX 3790”] (a hindered phenolic antioxidant)
1,3,5-tris[(4-tert-butyl-3-hydroxy-2,6-xyly l)methyl]-1,3,5-triazine-2,4,6(1H,3H,5H)-trione

Melting point: 161 degrees C.

(22) Antioxidant 3 [Manuf.: BASF JAPAN LTD., trade name: “IRGANOX 3114”] (a hindered phenolic antioxidant)
1,3,5-tris(3,5-di-tert-butyl-4-hydroxybenzy l)-1,3,5-triazine-2,4,6(1H, 3H, 5H) -trione

Melting point: 255 degrees C.

(23) Triazole derivative (copper inhibitor) [Manuf.: ADEKA CORPORATION, trade name: CDA-1]
3-(N-salicyloyl)amino-1,2,4-triazole

(24) Hydrazide metal deactivator [Manuf.: BASF JAPAN LTD., trade name: “IRGANOX MD1024”]
2,3-bis[3-(3,5-di-tert-butyl-4-hydroxyphen yl) propionyl]propiono hydrazide

(25) Zinc oxide [Manuf.: HAKUSUITECH CO., LTD., trade name: “ZINC OXIDE JIS1”]

(26) Zinc sulfide [Manuf.: SACHTLEBEN CHEMIE GMBH, trade name: “SACHTOLITH HD-S”]

(27) Imidazole compound [Manuf.: KAWAGUCHI CHEMICAL INDUSTRY CO,. LTD., trade name: “ANTAGE MB”]

(28) Lubricant 1 [Manuf.: NOF CORPORATION, trade name: “ALFLOW P10” (erucic acid amide)]

(29) Lubricant 2 [Manuf.: NOF CORPORATION, trade name: “BNT-22H” (behenic acid amide)]

(30) Crosslinking catalyst batch 1 [manuf.: MITSUBISHI CHEMICAL CORPORATION, trade name: “LINKLON LZ0515H” (a batch prepared by adding 1 part by mass of dibutyltin compound to 100 parts by mass of polyethylene and dispersed the dibutyltin compound in the polyethylene)]

(31) Crosslinking catalyst batch 2 [a batch prepared by adding 5 parts by mass of dibutyltin dilaurate to 100 parts by mass of polyethylene (NUC8122)]

(32) Crosslinking catalyst batch 3 [a batch prepared by adding 0.2 parts by mass of stannous acetate to 100 parts by mass of polyethylene (NUC8122)]

[Preparation of Flame Retardant Batches (b components)]

Flame retardant batches were prepared as follows: materials were prepared at the ratios of the b components of the Examples and Comparative Examples indicated in Tables 1 and 2, and each of the materials was put into a twin-screw kneading extruder. Each of the materials was heat-kneaded at 200 degrees C. for 0.1 to 2 minutes, and then was pelletized. The (1) to (4) silane-grafted polyolefins that are described above in the explanation of the materials used were used for the silane-grafted polyolefin batches of the a components. The (30) to (33) crosslinking catalyst batches 1 to 3 that are described above in the explanation of the materials used were used for the crosslinking catalyst batches of the c components.

[Preparation of Insulated Wires]

The silane-grafted polyolefin batches (the a components), the flame retardant batches (the b components), and the crosslinking catalyst batches (the c components) at the ratios of the Examples and Comparative Examples indicated in Tables 1 and 2 were blended by using a hopper of an extruder at about 180 to 200 degrees C., and subjected to extrusion processing. Conductors having an external diameter of 2.4 mm were extrusion-coated with thus-prepared materials as insulators having a thickness of 0.7mm (i.e. , the external diameter of the insulated wires after the extrusion-coating was 3.8 mm). Then, each of the materials was water-crosslinked in a bath at a high humidity of 95% at a high temperature of 65 degrees C. for 24 hours. Thus, insulated wires consistent with Examples and Comparative Examples were prepared.

Tests of gel fraction, productivity, flame retardancy, wire surface roughness, and wear resistance, long-time heating tests, and tests on a peel property were carried out on the obtained insulated wires, and evaluations were made. The evaluation results are presented in Tables 1 and 2. Test procedures and standards of evaluations are described below.

[Gel Fraction]

The gel fractions of the insulated wires were measured in accordance with the JASO-D608-92. To be specific, about 0.1 g of test samples of the insulators of the insulated wires were each weighed out in a balance and put in test tubes. 20 ml xylene was added to each sample, and then, each sample was heated in a constant temperature oil bath at 120 degrees C. for 24 hours. Then, each sample was taken out from the test tube to be dried in a dryer at 100 degrees C. for 6 hours. Each sample was cooled to room temperature and precisely weighed in a balance. The percentages of the masses of the test samples after the test to the masses of the test samples before the test were defined as gel fractions. The test samples having gel fractions equal to or more than 60% were rated “Excellent”. The test samples having gel fractions equal to or more than 50% were rated “Passed”. The test samples having gel fractions of less than 50% were rated “Failed” . The gel fraction is a generally used index of a water crosslinking state of a crosslinked wire.

[Productivity]

The linear speed of each insulated wire was increased and decreased when each insulated wire was being extruded. The insulated wires that could have a designed external diameter even at the linear speed equal to or more than 50 m/min were rated “Passed”. The insulated wires that could have a designed external diameter even at the linear speed equal to or more than 100 m/min were rated “Excellent”. The insulated wires that could not have a designed external diameter even at the linear speed less than 50 m/min were rated “Failed”.

[Flame Retardancy]

A flame retardancy test was carried out in accordance with the ISO 6722. The insulated wires that were extinguished within 70 seconds were rated “Passed”. The insulated wires that were not extinguished within 70 seconds were rated “Failed”.

[Wire Surface Roughness]

The measurements of average surface roughness (Ra) of the insulated wires were obtained with the use of a needle detector . The insulated wires of which Ra was less than 1 were rated “Passed” . The insulated wires of which Ra was less than 0.5 were rated “Excellent”. The insulated wires of which Ra was equal to or more than 1 were rated “Failed”. The measurement of the wire surface roughness was made with the use of SURFTEST SJ301 manufactured by MITUTOYO CORPORATION.

[Wear Resistance]

Wear resistance tests of the insulated wires were carried out in accordance with the ISO 6722. The insulated wires that could resist blade reciprocation of 1000 times or more were rated “Passed”, and the insulated wire that could not resist the blade reciprocation of 1000 times was rated “Failed”.

[Long-Time Heating Test]

Aging tests were each carried out on the insulated wires at 150 degrees C. for an arbitrary length of time, and then withstand voltage tests of 1 kv×1 minute were each carried out on the insulated wires. The insulated wires that were subjected to the aging tests for 3000 hours or more and could stand the withstand voltage tests without insulation breakdown were rated “Passed”. The insulated wires that were subjected to the aging tests for 5000 hours or more and could stand the withstand voltage tests without insulation breakdown were rated “Excellent”. The insulated wires that were subjected to the aging tests for 3000 hours and could not stand the withstand voltage tests without insulation breakdown were rated “Failed”.

[Peel Property]

Two wires of 100 mm that were wound by a tape were left at 150 degrees C. for 24 hours, and then the tape was removed from the two wires, and the two wires were detached from each other. The wires that were immediately detached from each other, and on which few adhesive residues were left were rated “Very good”. The wires that were immediately detached from each other, but on which a few adhesive residues were left were rated “Good”. The wires that were not easily detached from each other, and on which adhesive residues were totally left were rated “Poor”.

TABLE 1

| | | | Example 1 | | Example 2 | | Example 3 | | Example 4 | |
|---|---|---|---|---|---|---|---|---|---|---|
| | | | b | | b | | b | | b | |
| | No. | Component name | component | | component | | component | | component | |
| Component | 1 | Silane-grafted PP | | 30 | | | | | | |
| composition | 2 | Silane-grafted PE1 | | | | 60 | | | | |
| (Parts by mass) | 3 | Silane-grafted PE2 | | | | | | 90 | | |
| | 4 | Silane-grafted PE3 | | | | | | | | 60 |
| | 5 | Silane-grafted PE4 | | | | | | | | |
| | 6 | Silane-grafted EVA | | | | | | | | |
| | 7 | PP elastomer | 10 | | | | | | 5 | |
| | 8 | PE1 | 50 | | | | | | 30 | |
| | 9 | PE2 | | | 30 | | | | | |
| | 10 | PE3 | | | | | 5 | | | |
| | 11 | Maleic acid denatured PE | | | 10 | | | | 5 | |
| | 12 | Epoxy denatured PE | 10 | | | | | | | |
| | 13 | Maleic acid denatured PP | | | | | 5 | | | |
| | 14 | Bromine flame retardant 1 | | | | | | | | |
| | 15 | Bromine flame retardant 2 | | | 5 | | | | 50 | |
| | 16 | Bromine flame retardant 3 | 100 | | 5 | | 20 | | 20 | |
| | 17 | Antimony trioxide | 5 | | 3 | | 10 | | | |
| | 18 | Magnesium hydroxide | | | 30 | | | | | |
| | 19 | Calcium carbonate | | | | | | | | |
| | 20 | Zinc oxide 1 | | | | | | | | |
| | 21 | Zinc oxide 2 | 3 | | | | 0.5 | | | |
| | 22 | Zinc oxide 3 | | | 5 | | | | 3 | |
| | 23 | Triazole derivative | 0.2 | | 1 | | | | 1 | |
| | 24 | Hydrazide metal deactivator | | | | | 3 | | | |
| | 25 | Zinc oxide | 0.8 | | 5 | | 7 | | | |
| | 26 | Zinc sulfide | | | | | | | 5 | |
| | 27 | Imidazole compound | 0.8 | | 5 | | 7 | | | |
| | 28 | Lubricant 1 | | | | | | | 1 | |
| | 29 | Lubricant 2 | | | | | | | | |
| | 30 | Crosslinking catalyst batch 1 | | 3 | | | | | | |
| | 31 | Crosslinking catalyst batch 2 | | | | 5 | | | | |
| | 32 | Crosslinking catalyst batch 3 | | | | | | 1.8 | | 5 |

| | | | | | | | | |
|---|---|---|---|---|---|---|---|---|
| Subtotal | 179.8 | 33 | 99 | 65 | 57.5 | 91.8 | 120 | 65 |

| | | | | | |
|---|---|---|---|---|---|
| | Sum total | 212.8 | 164 | 149.3 | 185 |
| Test result | Gel fraction | Excellent | Passed | Passed | Passed |
| | Productivity | Passed | Excellent | Passed | Excellent |
| | Flame retardancy | Passed | Passed | Passed | Passed |
| | Wire surface roughness | Excellent | Excellent | Passed | Passed |
| | Wear resistance | Passed | Passed | Passed | Passed |
| | Long-time heating test | Passed | Excellent | Excellent | Passed |
| | Peel property | Good | Very good | Good | Very good |

| | | | Example 5 | | Example 6 | | Example 7 | |
|---|---|---|---|---|---|---|---|---|
| | | | b | | b | | b | |
| | No. | Component name | component | | component | | component | |
| Component | 1 | Silane-grafted PP | | | | | | |
| composition | 2 | Silane-grafted PE1 | | | | | | |
| (Parts by mass) | 3 | Silane-grafted PE2 | | | | | | 60 |
| | 4 | Silane-grafted PE3 | | | | | | |
| | 5 | Silane-grafted PE4 | | 60 | | | | |
| | 6 | Silane-grafted EVA | | | | 60 | | |
| | 7 | PP elastomer | | | | | 5 | |
| | 8 | PE1 | 5 | | | | 30 | |
| | 9 | PE2 | 30 | | | | | |
| | 10 | PE3 | | | 35 | | | |
| | 11 | Maleic acid denatured PE | 5 | | | | 5 | |
| | 12 | Epoxy denatured PE | | | | | | |
| | 13 | Maleic acid denatured PP | | | 5 | | | |
| | 14 | Bromine flame retardant 1 | | | 10 | | | |
| | 15 | Bromine flame retardant 2 | | | | | | |
| | 16 | Bromine flame retardant 3 | 10 | | 30 | | 30 | |
| | 17 | Antimony trioxide | 20 | | 70 | | 10 | |
| | 18 | Magnesium hydroxide | | | 50 | | | |
| | 19 | Calcium carbonate | 20 | | | | | |
| | 20 | Zinc oxide 1 | | | | | | |
| | 21 | Zinc oxide 2 | | | 1.5 | | | |
| | 22 | Zinc oxide 3 | 1.5 | | | | 3 | |
| | 23 | Triazole derivative | 1 | | 1 | | 1 | |
| | 24 | Hydrazide metal deactivator | | | | | | |
| | 25 | Zinc oxide | | | | | 10 | |
| | 26 | Zinc sulfide | 10 | | 15 | | | |
| | 27 | Imidazole compound | | | | | 10 | |
| | 28 | Lubricant 1 | | | 1 | | 1 | |
| | 29 | Lubricant 2 | 1 | | | | | |
| | 30 | Crosslinking catalyst batch 1 | | 5 | | | | 10 |
| | 31 | Crosslinking catalyst batch 2 | | | | | | |
| | 32 | Crosslinking catalyst batch 3 | | | | 5 | | |

| | | | | | | |
|---|---|---|---|---|---|---|
| Subtotal | 103.5 | 65 | 218.5 | 65 | 105 | 70 |

| | | | | |
|---|---|---|---|---|
| | Sum total | 168.5 | 283.5 | 175 |
| Test result | Gel fraction | Excellent | Excellent | Excellent |
| | Productivity | Excellent | Passed | Excellent |
| | Flame retardancy | Passed | Passed | Passed |
| | Wire surface roughness | Excellent | Passed | Excellent |
| | Wear resistance | Passed | Passed | Passed |
| | Long-time heating test | Excellent | Passed | Excellent |
| | Peel property | Very good | Good | Very good |

TABLE 1

| | | | Comparative | | Comparative | | Comparative | | Comparative | |
|---|---|---|---|---|---|---|---|---|---|---|
| | | | Example 1 | | Example 2 | | Example 3 | | Example 4 | |
| | | | b | | b | | b | | b | |
| | No. | Component name | component | | component | | component | | component | |
| Component | 1 | Silane-grafted PP | | 30 | | | | | | |
| composition | 2 | Silane-grafted PE1 | | | | 60 | | | | |
| (Parts by mass) | 3 | Silane-grafted PE2 | | | | | | 90 | | |
| | 4 | Silane-grafted PE3 | | | | | | | | 60 |
| | 5 | Silane-grafted PE4 | | | | | | | | |
| | 6 | Silane-grafted EVA | | | | | | | | |
| | 7 | PP elastomer | 10 | | | | | | 5 | |
| | 8 | PE1 | 50 | | | | | | 30 | |
| | 9 | PE2 | | | 30 | | | | | |
| | 10 | PE3 | | | | | 5 | | | |
| | 11 | Maleic acid denatured PE | | | 10 | | | | 5 | |
| | 12 | Epoxy denatured PE | 10 | | | | | | | |
| | 13 | Maleic acid denatured PP | | | | | | | | |
| | 14 | Bromine flame retardant 1 | | | | | | | | |
| | 15 | Bromine flame retardant 2 | | | 30 | | | | 50 | |
| | 16 | Bromine flame retardant 3 | | | | | 20 | | 20 | |
| | 17 | Antimony trioxide | | | 10 | | 10 | | | |
| | 18 | Magnesium hydroxide | | | 30 | | | | | |
| | 19 | Calcium carbonate | | | | | | | | |
| | 20 | Zinc oxide 1 | | | 5 | | | | | |
| | 21 | Zinc oxide 2 | 3 | | | | | | | |
| | 22 | Zinc oxide 3 | | | | | | | 3 | |
| | 23 | Triazole derivative | 0.2 | | 1 | | | | | |
| | 24 | Hydrazide metal deactivator | | | | | | | | |
| | 25 | Zinc oxide | 0.8 | | 5 | | 7 | | | |
| | 26 | Zinc sulfide | | | | | | | | |
| | 27 | Imidazole compound | 0.8 | | 5 | | 7 | | | |
| | 28 | Lubricant 1 | | | | | | | | |
| | 29 | Lubricant 2 | | | | | | | | |
| | 30 | Crosslinking catalyst batch 1 | | 3 | | | | | | |
| | 31 | Crosslinking catalyst batch 2 | | | | 5 | | | | |
| | 32 | Crosslinking catalyst batch 3 | | | | | | | | 5 |

| | | | | | | | | |
|---|---|---|---|---|---|---|---|---|
| Subtotal | 74.8 | 33 | 126 | 65 | 49 | 90 | 113 | 65 |

| | | | | | |
|---|---|---|---|---|---|
| | Sum total | 107.8 | 191 | 139 | 178 |
| Test result | Gel fraction | Failed | Passed | Failed | Excellent |
| | Productivity | Passed | Excellent | Passed | Excellent |
| | Flame retardancy | Failed | Passed | Passed | Passed |
| | Wire surface roughness | Excellent | Excellent | Passed | Passed |
| | Wear resistance | Passed | Passed | Passed | Passed |
| | Long-time heating test | Failed | Excellent | Failed | Failed |
| | Peel property | Good | Poor | Poor | Very good |

| | | | Comparative | | Comparative | | Comparative | |
|---|---|---|---|---|---|---|---|---|
| | | | Example 5 | | Example 6 | | Example 7 | |
| | | | b | | b | | b | |
| | No. | Component name | component | | component | | component | |
| Component | 1 | Silane-grafted PP | | | | | | |
| composition | 2 | Silane-grafted PE1 | | | | | | |
| (Parts by mass) | 3 | Silane-grafted PE2 | | | | | | |
| | 4 | Silane-grafted PE3 | | | | | | |
| | 5 | Silane-grafted PE4 | | 60 | | | | |
| | 6 | Silane-grafted EVA | | | | 100 | | |
| | 7 | PP elastomer | | | | | 5 | |
| | 8 | PE1 | 5 | | | | 90 | |
| | 9 | PE2 | 30 | | | | | |
| | 10 | PE3 | | | | | | |
| | 11 | Maleic acid denatured PE | 5 | | | | 5 | |
| | 12 | Epoxy denatured PE | | | | | | |
| | 13 | Maleic acid denatured PP | | | | | | |
| | 14 | Bromine flame retardant 1 | | | 10 | | | |
| | 15 | Bromine flame retardant 2 | | | | | | |
| | 16 | Bromine flame retardant 3 | 10 | | 30 | | 30 | |
| | 17 | Antimony trioxide | 20 | | 70 | | 10 | |
| | 18 | Magnesium hydroxide | | | 50 | | | |
| | 19 | Calcium carbonate | 20 | | | | | |
| | 20 | Zinc oxide 1 | 1.5 | | | | | |
| | 21 | Zinc oxide 2 | | | | | | |
| | 22 | Zinc oxide 3 | | | 3 | | 3 | |
| | 23 | Triazole derivative | 1 | | 1 | | 1 | |
| | 24 | Hydrazide metal deactivator | | | | | | |
| | 25 | Zinc oxide | | | | | 10 | |
| | 26 | Zinc sulfide | 10 | | | | | |
| | 27 | Imidazole compound | | | | | 10 | |
| | 28 | Lubricant 1 | | | 1 | | 1 | |
| | 29 | Lubricant 2 | 1 | | | | | |
| | 30 | Crosslinking catalyst batch 1 | | 5 | | | | 10 |
| | 31 | Crosslinking catalyst batch 2 | | | | | | |
| | 32 | Crosslinking catalyst batch 3 | | | | 5 | | |

| | | | | | | |
|---|---|---|---|---|---|---|
| Subtotal | 103.5 | 65 | 165 | 105 | 165 | 10 |

| | | | | |
|---|---|---|---|---|
| | Sum total | 168.5 | 270 | 175 |
| Test result | Gel fraction | Excellent | Excellent | Failed |
| | Productivity | Excellent | Failed | Excellent |
| | Flame retardancy | Passed | Passed | Passed |
| | Wire surface roughness | Excellent | Failed | Excellent |
| | Wear resistance | Passed | Failed | Passed |
| | Long-time heating test | Excellent | Failed | Failed |
| | Peel property | Poor | Very good | Poor |

As is evident from Table 2, the compositions consistent with Comparative Examples 1 to 7 did not contain all the components specified by the present invention, so that the insulated wires consistent with Comparative Examples 1 to 7 did not have properties that could satisfy the requirements of the insulated wires according to the present invention. To be specific, the composition consistent with Comparative Example 1 did not contain the bromine flame retardant while the composition consistent with Example 1 contained, so that the composition consistent with Comparative Example 1 was rated failed in flame retardancy, gel fraction, and a long-time heating test. The compositions consistent with Comparative Examples 2 and 5 did not contain the hindered phenolic antioxidant of triazine series having a melting point equal to or higher than 150 degrees C., so that the compositions consistent with Comparative Examples 2 and 5 were rated failed in peel property. The composition consistent with Comparative Example 3 did not contain the hindered phenolic antioxidant of triazine series having a melting point equal to or higher than 150 degrees C. or the crosslinking catalyst batch, so that the composition consistent with Comparative Example 3 was rated failed in gel fraction, and a long-time heating test, and peel property. The composition consistent with Comparative Example 4 did not contain the zinc oxide, the zinc sulfide, the triazole derivative or the hydrazide metal deactivator, so that the composition consistent with Comparative Example 4 was rated failed in a long-time heating test. The composition consistent with Comparative Example 5 did not contain the functional-group modified polyolefin or the flame retardant, so that the composition consistent with Comparative Example 5 was rated failed in gel fraction, flame retardancy, and an ISO long-time heating test.

The composition consistent with Comparative Example 6 did not contain the undenatured polyolefin, the functional-group modified polyolefin, or the zinc oxide and the imidazole compound or the zinc sulfide, so that the composition consistent with Comparative Example 6 was rated failed in productivity, wire surface roughness, wear resistance, and along-time heating test. The composition consistent with Comparative Example 7 did not contain the silane-grafted polyolefin, so that the composition consistent with Comparative Example 7 was rated failed in gel fraction, a long-time heating test, and peel property.

Meanwhile, as is evident from Table 1, the compositions consistent with present Examples 1 to 7 contain the silane-grafted polyolefin, the undenatured polyolefin, the functional-group modified polyolefin, the bromine flame retardant, the crosslinking catalyst batch, the zinc oxide and the imidazole compound or the zinc sulfide, the hindered phenolic antioxidant of triazine series having a melting point equal to or higher than 150 degrees C., and the triazole derivative or the hydrazide metal deactivator, so that the compositions consistent with present Examples 1 to 7 are rated passed all in gel fraction, productivity, flame retardancy, wire surface roughness, wear resistance, a long-time heating test, and peel property.

The foregoing description of the preferred embodiments of the present invention has been presented for purposes of illustration and description; however, it is not intended to be exhaustive or to limit the present invention to the precise form disclosed, and modifications and variations are possible as long as they do not deviate from the principles of the present invention.

1-8. (canceled)

9. A composition for a wire coating material, the composition containing:
(A) silane-grafted polyolefin that is polyolefin to which a silane coupling agent is grafted;
(B) undenatured polyolefin;
(C) functional-group modified polyolefin that is modified by a one or a plurality of functional groups selected from the group consisting of a carboxylic acid group, an acid anhydride group, an amino group, and an epoxy group;
(D) either one of
a bromine flame retardant having a phthalimide structure, and
a bromine flame retardant having a phthalimide structure and an antimony trioxide;
(E) a crosslinking catalyst batch that comprises a resin comprising a crosslinking catalyst that is dispersed in the resin;
(F) either one of
a zinc oxide and an imidazole compound, and
a zinc sulfide;
(G) a hindered phenolic antioxidant of triazine series having a melting point equal to or higher than 150 degrees C.; and
(H) either one of
a triazole derivative, and
a hydrazide metal deactivator.

10. The composition according to claim 9, wherein
the content of (A) the silane-grafted polyolefin is 30 to 90 parts by mass,
the total content of (B) the undenatured polyolefin and (C) the functional-group modified polyolefin is 10 to 70 parts by mass,
the content of (D) the either one of the bromine flame retardant having the phthalimide structure, and the bromine flame retardant having the phthalimide structure and the antimony trioxide is 10 to 70 parts by mass with respect to 100 parts by mass of the total content of the (A), (B) and (C) components,
the content of (E) the crosslinking catalyst batch is 2 to 20 parts by mass, in which the content of the crosslinking catalyst is 0.5 to 5 parts by mass with respect to 100 part by mass of the polyolefin,
the content of (F) each of the zinc oxide and the imidazole compound is 1 to 15 parts by mass, or the content of (F) the zinc sulfide is 1 to 15 parts by mass,
the content of (G) the hindered phenolic antioxidant of triazine series having the melting point equal to or higher than 150 degrees C. is 0.5 to 5 parts by mass, and
the content of (H) the either one of the triazole derivative, and the hydrazide metal deactivator is 0.3 to 3 parts by mass.

11. The composition according to claim 9, wherein each of the silane-grafted polyolefin and the undenatured polyolefin comprises a one or a plurality of polyethylene selected from the group consisting of very low density polyethylene, linear low density polyethylene, and low density polyethylene.

12. The composition according to claim 10, wherein each of the silane-grafted polyolefin and the undenatured polyolefin comprises a one or a plurality of polyethylene selected from the group consisting of very low density polyethylene, linear low density polyethylene, and low density polyethylene.

13. The composition according to claim 9, wherein (G) the hindered phenolic antioxidant comprises 1,3,5-tris(3,5-di-tert-butyl-4-hydroxybenzyl)-1,3,5-triazine-2,4,6(1H,3H,5H)-trione.

14. The composition according to claim 10, wherein (G) the hindered phenolic antioxidant comprises 1,3,5-tris(3,5-di-tert-butyl 1-4-hydroxybenzyl)-1,3,5-triazine-2,4,6(1H,3H,5H)-trione.

15. The composition according to claim 11, wherein (G) the hindered phenolic antioxidant comprises 1,3,5-tris(3,5-di-tert-butyl 1-4-hydroxybenzyl)-1,3,5-triazine-2,4,6(1H,3H,5H)-trione.

16. The composition according to claim 12, wherein (G) the hindered phenolic antioxidant comprises 1,3,5-tris(3,5-di-tert-butyl 1-4-hydroxybenzyl)-1,3,5-triazine-2,4,6(1H,3H,5H)-trione.

17. The composition according to claim 11, wherein (E) the crosslinking catalyst batch comprises a mixture that comprises
either one of very low density polyethylene, linear low density polyethylene, low density polyethylene, and high density polyethylene, and
a dibutyltin compound,
wherein the content of the dibutyltin compound is 0.5 to 5 parts by mass with respect to 100 parts by mass of the either one of very low density polyethylene, linear low density polyethylene, low density polyethylene, and high density polyethylene.

18. The composition according to claim 15, wherein (E) the crosslinking catalyst batch comprises a mixture that comprises
either one of very low density polyethylene, linear low density polyethylene, low density polyethylene, and high density polyethylene, and
a dibutyltin compound,
wherein the content of the dibutyltin compound is 0.5 to 5 parts by mass with respect to 100 parts by mass of the either one of very low density polyethylene, linear low density polyethylene, low density polyethylene, and high density polyethylene.

19. The composition according to claim 16, wherein (E) the crosslinking catalyst batch comprises a mixture that comprises
either one of very low density polyethylene, linear low density polyethylene, low density polyethylene, and high density polyethylene, and
a dibutyltin compound,
wherein the content of the dibutyltin compound is 0.5 to 5 parts by mass with respect to 100 parts by mass of the either one of very low density polyethylene, linear low density polyethylene, low density polyethylene, and high density polyethylene.

20. An insulated wire that comprises a wire coating material that comprises the composition for the wire coating material according to claim 9 that is water-crosslinked.

21. An insulated wire that comprises a wire coating material that comprises the composition for the wire coating material according to claim 10 that is water-crosslinked.

22. An insulated wire that comprises a wire coating material that comprises the composition for the wire coating material according to claim 11 that is water-crosslinked.

23. An insulated wire that comprises a wire coating material that comprises the composition for the wire coating material according to claim 18 that is water-crosslinked.

24. An insulated wire that comprises a wire coating material that comprises the composition for the wire coating material according to claim 19 that is water-crosslinked.

25. An insulated wire that comprises a wire coating material that comprises the composition for the wire coating material according to claim 9, the composition comprising:
a flame retardant batch that comprises
(B) the undenatured polyolefin,
(C) the functional-group modified polyolefin,
(D) the either one of the bromine flame retardant having the phthalimide structure, and the bromine flame retardant having the phthalimide structure and the antimony trioxide,
(F) the either one of the zinc oxide and the imidazole compound, and the zinc sulfide;
(G) the hindered phenolic antioxidant having the melting point equal to or higher than 150 degrees C., and
(H) the either one of the triazole derivative, and the hydrazide metal deactivator;
(A) the silane-grafted polyolefin; and
(E) the crosslinking catalyst batch,
wherein the flame retardant batch, (A) the silane-grafted polyolefin, and (E) the crosslinking catalyst batch are kneaded to be molded around a conductor, and is water-crosslinked.

26. An insulated wire that comprises a wire coating material that comprises the composition for the wire coating material according to claim 10, the composition comprising:
a flame retardant batch that comprises
(B) the undenatured polyolefin,
(C) the functional-group modified polyolefin,
(D) the either one of the bromine flame retardant having the phthalimide structure, and the bromine flame retardant having the phthalimide structure and the antimony trioxide,
(F) the either one of the zinc oxide and the imidazole compound, and the zinc sulfide;
(G) the hindered phenolic antioxidant having the melting point equal to or higher than 150 degrees C., and
(H) the either one of the triazole derivative, and the hydrazide metal deactivator;
(A) the silane-grafted polyolefin; and
(E) the crosslinking catalyst batch,
wherein the flame retardant batch, (A) the silane-grafted polyolefin, and (E) the crosslinking catalyst batch are kneaded to be molded around a conductor, and is water-crosslinked.

27. An insulated wire that comprises a wire coating material that comprises the composition for the wire coating material according to claim 11, the composition comprising:
a flame retardant batch that comprises
(B) the undenatured polyolefin,
(C) the functional-group modified polyolefin,
(D) the either one of the bromine flame retardant having the phthalimide structure, and the bromine flame retardant having the phthalimide structure and the antimony trioxide,
(F) the either one of the zinc oxide and the imidazole compound, and the zinc sulfide;
(G) the hindered phenolic antioxidant having the melting point equal to or higher than 150 degrees C., and
(H) the either one of the triazole derivative, and the hydrazide metal deactivator;
(A) the silane-grafted polyolefin; and
(E) the crosslinking catalyst batch,
wherein the flame retardant batch, (A) the silane-grafted polyolefin, and (E) the crosslinking catalyst batch are kneaded to be molded around a conductor, and is water-crosslinked.

28. An insulated wire that comprises a wire coating material that comprises the composition for the wire coating material according to claim 18, the composition comprising:
a flame retardant batch that comprises
(B) the undenatured polyolefin,
(C) the functional-group modified polyolefin,
(D) the either one of the bromine flame retardant having the phthalimide structure, and the bromine flame retardant having the phthalimide structure and the antimony trioxide,
(F) the either one of the zinc oxide and the imidazole compound, and the zinc sulfide;
(G) the hindered phenolic antioxidant having the melting point equal to or higher than 150 degrees C., and
(H) the either one of the triazole derivative, and the hydrazide metal deactivator;
(A) the silane-grafted polyolefin; and
(E) the crosslinking catalyst batch,
wherein the flame retardant batch, (A) the silane-grafted polyolefin, and (E) the crosslinking catalyst batch are kneaded to be molded around a conductor, and is water-crosslinked.

29. An insulated wire that comprises a wire coating material that comprises the composition for the wire coating material according to claim 19, the composition comprising:
a flame retardant batch that comprises
(B) the undenatured polyolefin,
(C) the functional-group modified polyolefin,
(D) the either one of the bromine flame retardant having the phthalimide structure, and the bromine flame retardant having the phthalimide structure and the antimony trioxide,
(F) the either one of the zinc oxide and the imidazole compound, and the zinc sulfide;
(G) the hindered phenolic antioxidant having the melting point equal to or higher than 150 degrees C., and
(H) the either one of the triazole derivative, and the hydrazide metal deactivator;
(A) the silane-grafted polyolefin; and
(E) the crosslinking catalyst batch,
wherein the flame retardant batch, (A) the silane-grafted polyolefin, and (E) the crosslinking catalyst batch are kneaded to be molded around a conductor, and is water-crosslinked.

30. A wiring harness for automobile that comprises the insulated wire according to claim 23.

31. A wiring harness for automobile that comprises the insulated wire according to claim 24.

32. A wiring harness for automobile that comprises the insulated wire according to claim 28.

33. A wiring harness for automobile that comprises the insulated wire according to claim 29.
